(19) United States
(12) Patent Application Publication
(10) Pub. No.: US 2019/0156406 A1
(43) Pub. Date: May 23, 2019

(54) METHOD AND SYSTEM FOR APARTMENT RENTAL INSPECTIONS WITHOUT PRESENCE OF BROKERS OR RENTAL AGENTS

(71) Applicant: Cazamio LLC, Monroe, NY (US)

(72) Inventors: Sholomo Landau, Monroe, NY (US); Joel Loeb, Monroe, NY (US); Yosef Loeb, Monroe, NY (US); Jonas Sison, Monroe, NY (US)

(21) Appl. No.: 15/820,642

(22) Filed: Nov. 22, 2017

(51) Int. Cl. G06Q 30/06; G06Q 50/16; G06Q 30/02; G06Q 10/10; G07C 9/00

(52) U.S. Cl. CPC G06Q 30/0645; G06Q 50/16; G06Q 30/0277; G07C 9/00904; G06Q 10/1095; G07C 9/00571; G07C 9/00126; G06Q 30/0281

(57) ABSTRACT

A system for facilitating real estate (RE) unit rentals by intermediating landlords and potential tenants (PT) and enabling RE unit inspections and viewing without requiring on-site landlord representatives. The system includes a master-server facility including software modules and databases for executing system algorithms that enable and control communications between landlord communication devices, PT devices and apartment devices including a remote door lock, cameras and movement sensors. The door lock is remotely-operable and wirelessly controlled. The apartment devices include communication and monitoring devices temporarily installed in the RE units to enable RE unit inspections and viewing. The software modules including at least: a) a unit listing software; b) a tenant liaison module; c) an inspection scheduling module; d) a door opening module that sends to the PT devices at least one activation code for the door lock; and e) a tenant present module that verifies that the potential tenant is located in proximity to the entry door.

### BACKGROUND OF THE INVENTION

The present invention is generally directed to a system and method for apartment rentals and, more particularly, to a system and method for apartment rentals in which prospective tenants can connect with landlords on a full-featured online platform, which allows for viewing and visiting apartments remotely and/or in-person without reliance on middleman realtors at any point of the transaction.

Traditionally, the real estate rental market is a highly localized, a relationship-based industry driven largely by individuals living and working in their own cities. Early innovators like Zillow® and Trulia® primarily entailed bringing real estate data online. Newer innovators harness data not only to improve analytics for landlords, but also to improve efficiency for apartment seekers. Thus, the market has begun to shift n early every aspect of the rental process, from leasing applications to communications with landlords and agents to payment processing, to on-line systems. Many prospective apartment renters have turned to Craigslist, which lists apartments for rent. But that experience often does not comport with today's digital-savvy and very busy renters, who still must disrupt their busy careers and work days, and adjust their busy schedules to suit the availabilities of broker agents for in-person rental inspections. In today's highly digitized world, renters have to arrange multiple apartment viewing appointments that are day and time constrained and often quite inconvenient.

Some progress has been described including by real estate startup Oliver®, which in 2015 launched a system that serves as a platform that cuts out the middleman and seamlessly connects renters with apartment owners/renters. The Oliver app enables renters not only to browse and filter listings as could be done on other platforms, but also to schedule showings at the tap of a button using an in-app calendar feature. Rezi (https://www.rentrezi.com), an earlier-stage New York startup, also saves time by automatically scheduling multiple apartment visits to fit its users' schedules.

But none of the existing systems have even contemplated a system and method that counter-intuitively allows prospective renters to view and inspect apartments at any time of the day (or even throughout the night) without any landlord representative being present, in a manner that protects the apartments' physical integrity, the prospective renters and the residents of the buildings where the available apartment(s) are located.

### SUMMARY OF THE INVENTION

It is an object of the present invention to provide a system and method that dispenses with the need for landlord or lessor representatives being physically present during apartment inspections by potential apartment renters or lessees.

It is a further object of the present invention to provide the aforementioned, representative-free apartment renting system in a format that protects the physical integrity of the apartments and their contents, while also providing safety features for residents of the building where the inspected apartments are located.

It is yet another object of the invention to provide a representative-free apartment rental inspection system which is web enabled.

Yet another object of the invention is to provide a representative-free rental apartment inspection system that can be inexpensively implemented.

The foregoing and other objects of the invention are realized by a system that, broadly speaking, utilizes a software platform that through its APIs connects with a variety of smart-lock hardware systems through that hardware's API. One may consider software as constituting a universal key to the many different and various smart-lock systems available generally in the marketplace today or which might be introduced at future times.

The software platform also connects to a variety of cameras and security systems installed in the various apartment buildings and apartment units. The platform provides for easy viewing for security, remote viewing, as well as maintenance services.

When a user requests access to visit an apartment, a quick online background check is performed remotely through a third-party service to verify the user's identity and trust-worthiness within the web or mobile software application. Once verified, user may visit an apartment without the need for scheduling and/or notifying the landlord through any other means. The user may enter a building and unit simply through utilizing the application as a key to gain access to buildings and rental units.

When the user accesses or enters a rental apartment, the user's time of entry is monitored. An alert is sent to the user after 20 minutes (or another time period, as the system may be reprogrammed to provide) informing the user that the inspection period has passed and asking the user if they are still in the apartment. If there is no response from the user within two or so minutes, an alert is sent to the landlord (and landlord's team). In addition to the non-response, the user's GPS coordinates through the smartphone application will help indicate that the user has left the premises. The landlord will then receive an email of the screenshot of the apartment through the system's video feed of the apartment. This will help confirm that the user has left the premises.

In some instances, the renter may not have the means to visit the apartment. However, the same system has also the capability to allow such renter to view the interior of the apartment through the online platform in which live images of the current apartment is available. The platform allows the user to be able to view both pre-shot photos of the apartment as well as direct its temporarily installed cameras to allow a walk-through of the apartment through 360/VR videos of the apartment.

Once a tenant applies for the apartment in question, the landlord will decide whether to approve or decline the apartment through the software platform. The system's ability to provide a single application and credit report may also be utilized for being re-used to allow the same potential renter to reapply for other apartments, of the same or different landlords and different apartment units. If the landlord does not find any suitable renters for his apartment, the software platform can release to the landlord (if previously approved by the potential renters) a list of individuals seeking apartments whom the landlord can thereby contact either for proposing apartments or special offers on apartment rentals and the like.

If a user gets rejected from an apartment listing, the user will then receive a “request to be matched” notice for other similar apartments in size, price, amenities and location. Should the user accept such request, the system, through its algorithm will match the user with other apartment units.

In accordance with a preferred, more detailed embodiment of the invention, the present invention is realized by means of a system for facilitating real estate (RE) unit rentals by intermediating landlords and potential tenants (PT) and enabling RE unit inspections and viewing without requiring on-site landlord representatives, the system comprising: a master-server facility including software modules and databases for executing system algorithms that enable and control communications between landlord communication devices, PT devices and apartment devices; a respective, remotely-operable and wirelessly controlled door lock installed on an entry door of the RE unit; said apartment devices including communication and monitoring devices temporarily installed in the RE units to enable said RE unit inspections and viewing; said software modules including at least: a) a unit listing software module that receives unit listing information from the landlords, said information including and identifying the locations, identities and additional information for the RE units available for rental, said unit listing software module listing the RE units information in a manner accessible for viewing by the PT; b) a tenant liaison module that is configured to allow tenants to communicate to the landlords their desire to inspect one or more specified ones of the listed RE units at desired time slots; c) an inspection scheduling module that is configured to schedule inspection visits of a given PT, in a manner that does not conflict or interfere with previously scheduled inspections and prospective inspection schedules by other PT; d) a door opening module that sends to the PT devices at least one activation code for the door lock; and e) a tenant present module that verifies that the potential tenant is located in proximity to the entry door which enables the lock and activates the lock to unlock when activated by the PT devices.

In a preferred embodiment, the door opening module is configured so that said door lock is activated to remain unlocked for a predetermined, programmable time period and self-locks thereafter, the apartment hardware comprises video equipment that produces live video content that is communicated to the master-server facility in a manner accessible to being remotely viewed. The apartment hardware comprises audio recording equipment for enabling audio communication of sounds within the RE unit and communicating said audio content to said master-server facility, the monitoring devices comprise several movement detectors temporarily located in the RE unit, the monitoring devices comprise perimeter protection devices that can be placed around valuable appliances in the RE unit and report any attempt to touch or remove said appliances, the software modules include an advertising module that is configured to place advertising content in advertising media channels, to advertise said available RE units and to provide directions to access the system of the present invention to view said RE units, the apartment devices comprise a lobby door controller and wherein said software modules comprise lobby door control software that operates to enable the PT to gain access to a multi-dwelling apartment unit through a lobby door, and the tenant present module comprises a facility that is GPS activated and which is configured to transmit to the master-server facility GPS coordinates corresponding to a physical location of the PT, to assure that the PT device is located adjacent to the door lock.

In a preferred embodiment, the software modules include a leasing services module configured to provide to the PT leasing forms and information that streamlines letting of the RE units, the software module comprises a PT communication module that is configured to allow the PT who had inspected the RE units to provide feedback information and comments to the landlords, the software module comprises a landlord report module that provides regular and organized reports on the apartment inspections and leasing of the RE units, the software module comprises a PT verification module, which is configured to conduct background investigations and verifications of the PTs before authorizing PTs for scheduled inspections of the RE units, the software module comprises an information organizing module, that is configured to allow PTs to segregate information about the RE units relative to geographical locations, particular landlords, rent levels, and/or RE unit apartment sizes, and the tenant-present module comprises a facility that randomly activates said movement devices to detect movements inside said RE units during times when no one has been scheduled to be in the RE unit.

Other features and advantages of the present invention will become apparent from the following description of the invention which refers to the accompanying drawings.

### BRIEF DESCRIPTION OF THE DRAWING(S)

FIG. 1 is an overall block diagram of various hardware components, software modules and entities that comprise the overall system of the present invention, in a simplified form thereof.

FIG. 2 is a diagram of a typical apartment for rent and various hardware components located therein.

FIGS. 3A, 3B and 3C are software platform block diagrams of software components and platforms that relate to owner/landlord functionalities.

FIG. 4 is a block diagram that depicts functionalities and components that relate to users and tenants.

FIG. 5 is another diagram that relates to user/tenant functionalities.

FIGS. 6A and 6B are yet another block diagrams that relate to user/tenant software and hardware functionalities.

### DETAILED DESCRIPTION OF EMBODIMENTS OF THE INVENTION

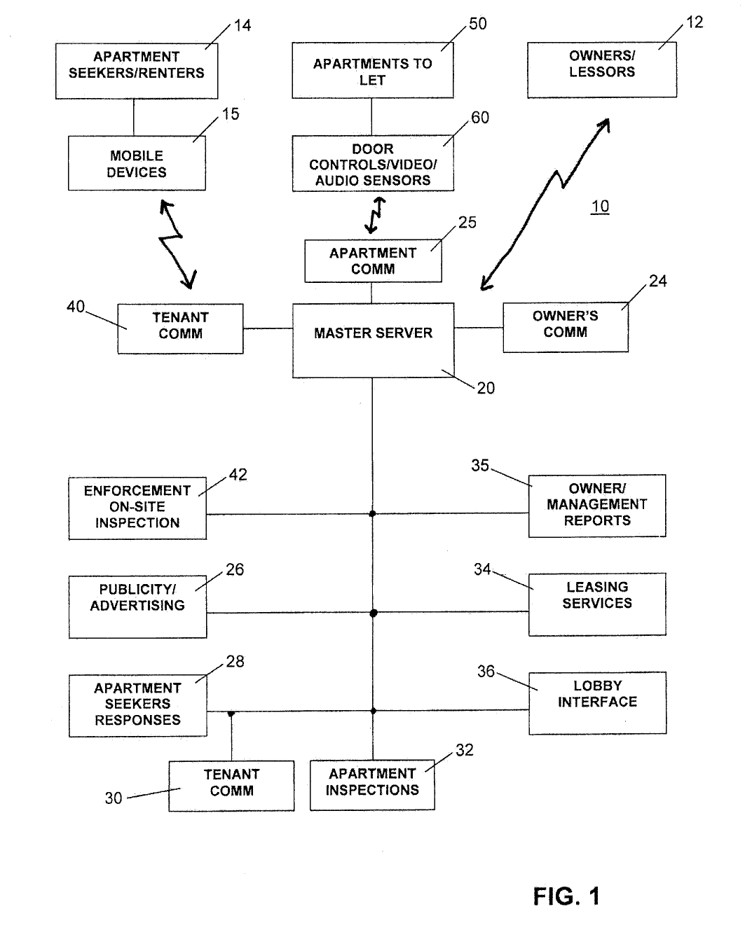

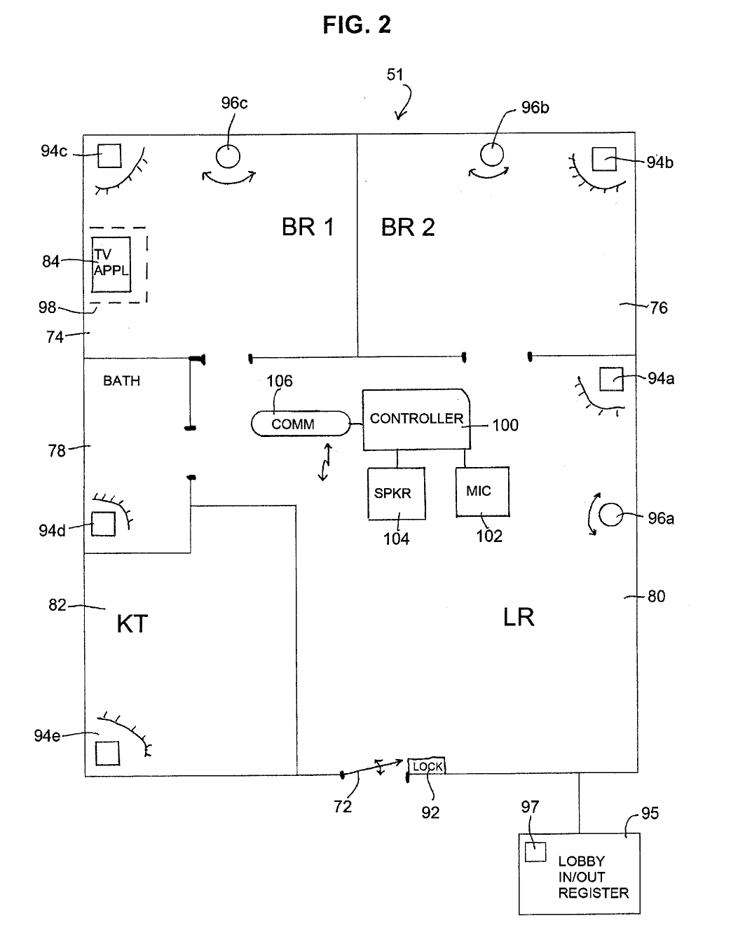

By way of introduction, initial reference is directed to the overall block diagram of FIG. 1 which provides a map of the Representative-Free System 10 of the present invention, which is primarily a software platform that interfaces Owners/Lessors/Renters 12 to a Master Server 20, which contains the primary software platform that enables the Renters 12 to find prospective Apartment Seekers/Renters 14 for their available Rental Apartments 50. The Apartments 50 have located therein physical devices, referred to collectively as the Apartment Hardware 60 that may include a door controller and other video and audio monitors as well as motion sensors and the like (as will be later described relative to FIG. 2).

In general, the Master Server 20 communicates with the Apartment Seekers 14 via a Tenant Communication Module 40, and similarly communicates with the Apartment Owners 12 via an owner's Communication Interface 24 and, similarly, with the Apartment-Based Hardware 60 via an Apartment Communication Interface 25.

The Master Server 20 is preferably set up to handle a great range of functionalities including the advertising and listing of apartments in a Publicity/Advertising Module 26. Another software module comprises the Tenant Responses 28 which are utilized to provide information to the Owners/Lessors and to set up visiting appointments. The Tenant Screening Module 30 is responsible for conducting background checks on potential tenants. The Apartment Inspection Module 32 is responsible for setting up the visiting times and to alert/initiate/enable the apartment hardware and accessories about upcoming visits by specific ones of the apartment seekers and to communicate to mobile devices of the Apartment Seekers 15 the information about the availability of inspections and the time slots allocated, to avoid conflicts and leave time between visitors. An apartment seeker might simultaneously arrange multiple visits at several potential apartments belonging to the same apartment owner or to different ones. The Leasing Module 34 may be responsible for accepting rental offers and for attending to the formalities associated with concluding a lease agreement with an apartment seeker. The module Owner/Management Reports 35 contains the report writers that the system uses to transmit reports to the apartment owners and/or management entities.

The Lobby Module 36 is another module that provides a software function that enables a lobby facility to allow entry through a lobby area of a building, prior to the Apartment Seeker 14 being permitted to proceed to elevators or staircases to individual apartments. The specific modes of operations in accordance with preferred embodiments of the invention are described further on.

With reference to FIG. 2, there is provided a diagrammatic layout of a Typical Apartment 51, for example one that has a Main Door 72 which is kept locked by a Remotely Operable Lock 92, and which, when enabled by the system of the present invention, allows access to the apartment's Living Room 80, Kitchen 82, First Bedroom 74, Second Bedroom 76 and a Bathroom 78. When this apartment is available and requires renting, either the owners or the rental agent can preferably place inside the apartment various monitoring devices and sensors including Video Monitors 94a, 94b, 94c, 94d and 94e, each of which may be mounted on a pole and slanted down and having a wide, panoramic video monitoring capability, sending their signals through, for example a local Bluetooth transmission node, to the Local Controller 100 via a Communication Receiver 106. The Controller 100 is also able to listen to audio spoken in the apartment through a Microphone 102 and to respond to visitors through a Speaker 104.

Other implements within the apartment can comprise a Motion Detector 90, for example, multiple Motion Detectors 96a, 96b, 96c and the like in every area which can detect any motion and issue an alarm which communicates to the Controller 100 even when there are no scheduled visitors, thereby limiting the amount of data flow from the apartment to the Master Server 20. The overall Video/Audio/Sensor Assembly 70 can be easily moved from apartment to apartment at low cost when an apartment is ready for rental and is easily removed from the apartment once the rental process has concluded, as no hard wiring of electrical components is required. It should be appreciated that if a visitor attempts to disconnect or block or turn away any of the monitoring devices, the appropriate alarms can be sounded and the owner or rental agency immediately alerted. The monitoring devices may also include a Perimeter Protecting Frame 98, which comprises several rectangular frames that contain in the frame members electronic eye technology that can protect, for example, television and other Valuables 84 that may be in the apartment, preventing their being removed by sounding an alarm if anyone reaches with their hands or any other body parts or even with a tool in attempts to reach the television or the like for removal from the apartment.

The Lobby In/Out Registration Hardware 95 may comprise a Reader 97 against which a mobile device of a potential renter can be placed to open a main door or a lobby door into the building and to register when the approved visitors have left and simultaneously provide an alert if those visitors have not left within a given time period.

In general therefore, the System 10 comprises the Master Server 20 communicating with mobile devices of prospective tenants and those of landlords/renters as well as with software/hardware devices located in the rental apartments. As to the actual system implementation, the System 10 can be provided in owner hardware or be web based and cloud operated.

For example, and in connection with the mobile platforms, the application may provide one or more client applications with support for audio/video, as supported by corresponding phones. The application supports one or more of the following phone platforms, or another of like kind: ANDROID MOBILE/TABLET; IPHONE/IPAD iOS; BLACKBERRY; AND WINDOWS MOBILE. In connection with web browser software applications, the present application supports many applications, including web browser software applications that include a FLASH plug-in, HTML or any display-rendering language, or other multi-media supporting tools. The communication application may provide integration with popular instant messaging (“IM”) networks, such as GTALK/MSN, MESSENGER/YAHOO/AIM, /ICQ/FACEBOOK/MYSPACE. One or more of the following API calls may be provided or otherwise available: LinkAccount; GetBuddyList; SendMessage; ReceiveMessage; SubscribeUpdates; and RemoveAccount.

In connection with the server side APIs, various server side API calls may be provided via standard Internet web services, in various open source platforms, such as PYTHON, or in proprietary platforms. Accordingly, the present application may provide web services, without a need to support or otherwise provide language-specified API's. Thus, the present application provides one or more APIs for integrating audio/video chat functionality. A client API, for example, using HTML5 and Bandwidth Dispersion application(s) may be provided and installed on a user's computer to optimize bandwidth usage. For example, an installable application may be provided for client computers. Video/audio feeds may be broadcast peer to peer, as long as bandwidth is available on client's PC. In the event there is not enough bandwidth the application utilizes one or more servers for broadcasting video/audio feeds.

Moreover, APIs for virtually unlimited web browser and mobile for example (Android/iOS/RIM) HD HTML5/CSS3/Web-Kit-based group video conferencing with video and audio recording are provided. The present application may include a bandwidth dispersion technique, and analytics for video chat usage. Further, cross-platform integration is supported for video chat, and users may be able to video chat with renters, or family and friends, using exterior services as well as within one or more “interior” web and mobile applications. This may include exterior services that may or may not contain native video chat support. Examples include AIM/ICHAT, GCHAT/GOOGLE applications, FACEBOOK chat/messaging, SKYPE, native ANDROID video chat (activated by calling phone number), FACETIME/IOS (activated by calling phone number), native RIM video chat client (activated by calling phone number), native WINDOWS mobile video chat (activated by calling phone number), native WINDOWS 7 video chat client/LYNC, native EXCHANGE video chat client (if applicable), native LOTUS client (IBM Same time) (if applicable), and WEBX desktop client (if applicable).

The System 10 may include at least one information processor (configured to operate as an Internet web server and/or database file server) that is programmed and configured to access the aforementioned communication networks to reach the mobile devices operating with one or more of the GOOGLE ANDROID, APPLE IOS, WINDOWS MOBILE operating systems, and may include smartphone devices, tablet computing devices, or other mobile portable devices. The mobile devices may communicate via the known communications protocol, Transmission Control Protocol/Internet Protocol “TCP/IP”. In a preferred embodiment, the information processor(s) and mobile devices may be equipped with web browser software, such as MICROSOFT INTERNET EXPLORER, MOZILLA FIREFOX, GOOGLE CHROME, APPLE SAFARI or the like.

The functional elements of the Server 20 may include one or more central processing units (CPU) used to execute software code and control operations. Other elements (not shown) include (conventionally) read-only memory (ROM), random access memory (RAM), one or more network interfaces to transmit and receive data to and from other devices across a communication network, storage devices such as a hard disk drive, floppy disk drive, tape drive, CD ROM or DVD for storing program code databases and application data, one or more input devices such as a keyboard, mouse, track ball, microphone and the like, and a display.

The various components illustrated in FIG. 1 need not be physically contained within a single device chassis or even located in a single location. For example, a storage device may be located at a site that is remote from the remaining elements of Information Processor 20, and may even be connected to a CPU across communication networks via a network interface. Information processor may include a memory equipped with sufficient storage, such as to provide or access the necessary databases, forums, and other community services communicating hypertext markup language (HTML), Java applets, and/or Active-X control programs.

The nature of the present application is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and RUBY ON RAILS.

The System 10 functionalities lend themselves to be presented as below:

1. Landlord Registration

(a) System requests standard info, e.g. name, address and phone number. System prompts owner to register individual buildings. And upload general photos of the building, e.g. facade, backyard, common areas, gym, roof deck, laundry room, etc.
(b) Admin verifies Building ownership by virtue of official documentation.
(c) System prompts owner to enter a desirable time frame as to when users can enter their properties. This can be building specific or otherwise.
(d) System prompts owner to enter general rules (“Prime Rules”) leasing terms, amount of deposit needed and the terms of the fee. I.e. which party pays the fee, etc. This can be building specific or otherwise.′
(e) Account established!
(f) System prompts owner to download and login to App.

2. Listing Vacant Apartments by Owner

(a) Owner signs in to his/her account established in step
(b) Selects/types Building and adds the unit number.
(c) Changes status from occupied to vacant.
(d) System will request account holder to link Credit card/Bank info.
(e) System will authenticate payment info.
(f) System will charge a not yet determined amount as a deposit.
(g) Admin will ship out (Via overnight delivery) Device.
(h) Owner receives Tracking information.
(i) Owner receives device!

3. Installation of Device

(a) Device is attached, by owner, to the front door of the vacant apartment by following instructions on a multilingual card included with the device. (Video instructions will be available as well, on the app).
(b) Owner opens app (Owner's end app) and follows on-screen instructions to scan barcode on device to register the particular apartment to the particular device.
(c) Availability date and lease terms are entered.
(d) App presents owner with a checklist (Some mandatory and the rest voluntary) e.g. number of bedrooms, bathrooms, appliances selection, gym, roof deck, etc.
(e) App prompts owner to take photos, within the app, of the apartment.
(f) On-screen instructions will advise the order in which photos of particular rooms should be taken. (including the prime photo) Instruction will be provided as well as to what to include in the photo. E.g. inclusion on appliances in the kitchen photo, full views of windows in the living room, etc. App will provide on-screen helpful tips on angle options. Panorama photography will be optional.
(g) Comments can be added. (optional)
(h) Information is saved and posted by system.
(i) System will advise owner to clean apartment, change light bulbs, making sure unit is visibly marked, etc.
(j) System will ask owner to confirm the general details entered when established account.
(k) System will allow changing the rules for this individual apartment, e.g. lower deposit amount. Longer/shorter lease term, etc. to change the “Prime rules” the owner needs to be logged in via a desktop.
(l) Listing upload complete!

4. Browsing of Available Apartments by User on App/Desktop

(a) User selects a geographic area using Zip code, city, neighborhood, etc. User has the option to select listings by selecting “Near Me”.
(b) User can filter results by selecting specific amenities, size, price range, etc.
(c) System displays results, based on user input provided in previous step. Listings show as the first photo taken by owner, (Prime photo) availability, price, room count and location.
(d) Clicking on a particular post will display additional info. E.g. Checklist provided by owner, comments, nearest subway station, bus line, laundromat, availability date, lease terms, street view by Google, etc.
(e) Users can “save” any apartment in their profile so as to be able to come back at another time to review the apartment. User can also request to be updated if the status of the particular apartment changes. User can always opt out of receiving notifications.
(f) User can “share” the apartment by the way of Email, Text, social media, etc.

5. User Registration

(a) User selects a desirable apartment and hits “View Now”.
(b) System prompts user to sign up.
(c) User has the option to sign up manually, via Facebook and Google, etc.
(d) System will prompt user to authenticate phone.
(e) Some form of proof of Identification will be requested by system.
(f) System authenticates ID.
(g) User account has been established and is ready to use!

6. Viewing of Physical Apartment by User (App Only)

(a) User clicks again “View Now” on the desirable apartment listing.
(b) App shows the time frame in which apartment can be visited.
(c) App offers GPS guidance to selected property.
(d) Upon getting to destination (system will know user's location by use of his/her phone's GPS) user's phone will automatically connect, Via Bluetooth, to the main building entrance.
(e) User will hit “Open now” and system will buzz the user into the entrance hall.
(f) User will approach the particular apartment.
(g) At this time the outdoor camera on the device is activated.
(h) Phone will connect, Via Bluetooth, to the Device installed by the owner. (Step 3).
(i) Once connectivity is established user will hit “Open Now” (which has now turned from grey to green).
(j) Device can either turn/lock mechanically or just automatically lock by disengaging. (When turning from the outside, handle does not catch).
(k) At this time the indoor camera on the device is activated.
(l) User gets a notification that he/she has 20 minutes to view apartment, the amount of time given to user to inspect apartment. Informed about being recorded, etc.
(m) After 90% of the given time has passed, user gets notification and an option to extend the time is offered.
(n) A reminder is given to user, either on-screen or by way of notification, to close lights when exiting unit, etc.
(o) User exits apartment and hits “close now”.
(p) System prompts user for feedback. Like/dislike the apartment. And follow up with a number of Questions; say 3, based on the first answer.
(q) At this point, should he/she choose so, the owner can be notified by system that a user has viewed the apartment.
(r) Device mechanically locks door.
(s) User now has the option to ask questions from the owner by hitting “Help Me”. System facilitates the conversation between user and owner. Conversation will be anonymous at this point. (Parties can exchange personal info if they so desire).

7. Applying for Apartment by User

(a) User has option to “lock Down” apartment without communicating with landlord. System will prompt user to enter payment info, charge a not yet determined amount of money, to hold the apartment for a not yet determined amount of time.
(b) Should user decide to lock down (hold) the apartment, system will automatically update the listing and notify the owner by way of notification and displaying a lock in the owner's dashboard. Owner and other users should be able to see when hold expires.
(c) User can also choose to apply without a hold.
(d) Other users can now request to be notified when apartment is either rented or hold has expired without leading to a lease signing.
(e) User can now log in to his account via his app or desktop to start the application process. (Sample application included) Amount of questions is TBD
(f) System will prompt user to upload documents to the designated slots. E.g. ID, W2/1099, paystubs, etc.
(g) User will have optional slots to upload a recommendation letter, etc.
(h) System will prompt user to provide payment for credit check.
(i) Once all the mandatory documents have been uploaded and only then will the system sends the complete renter profile, including the credit report, to the owner.
(j) At this point the status of the apartment will change to “Application Pending” the status update will be visible to other users and to the owner. Users that requested to be updated will be notified as well.

8. Approval Process

(a) Owner gets a notification with a brief summary of renter. E.g. amount of intended occupants, credit score and income.
(b) Owner can now login to his/her account and view the complete application and credit report.
(c) Owner has the option to hit “approved” or “declined” (with reason?)
(d) Owner also has the option to contact the user to ask for additional info, explanations to discrepancies, conditions, Insurant, etc.
(e) Once owner reaches a decision to approve or otherwise. Status is again updated to “approved application” and notifications are sent out to users who requested so.
(f) Owner provides user with information regarding lease signing. E.g. amount needed, time and place of lease signing, etc.
(g) Once leased is signed, owner will hit “Lease Signed” on the dashboard.

9. Removal of Listing and Return of Device

(a) System will update the status to “Rented” and remove the particular listing from the System and from user profiles that saved the apartment.
(b) At this point, the owner's/user's pre-selected payment option will be used by system to charge for the services provided.
(c) Owner removes device from door and returns it to Admin within a specific time frame.
(d) Admin inspects device for visible blemishes and missing parts, etc.
(e) System refunds device deposit to owner.

10. Owner Abilities Via System

(a) Owner can always login to his/her dashboard to change settings, see how many times a particular listing has been clicked, and see how many visitors any particular apartment has had in a specific time frame. Down to the hour.
(b) Owner will have access to a log, via dashboard. Log will show in detail every visit with the ability to playback the video captured while the user was in the apartment.
(c) Dashboard will show on desktop and owners end app, the current status of apartments.
(d) Rented, hold, application pending, if door is locked, etc.
(e) Owner can turn on/off both cameras on the device remotely at any given time.
(f) Owner can remotely lock, and unlock door at any given time.

### (g) Admin=System+Personal

(h) Owner=Landlord, property manager or their staff
(i) System=Back end office/automation
(j) Device=Door sleeve
(k) User=Potential tenant

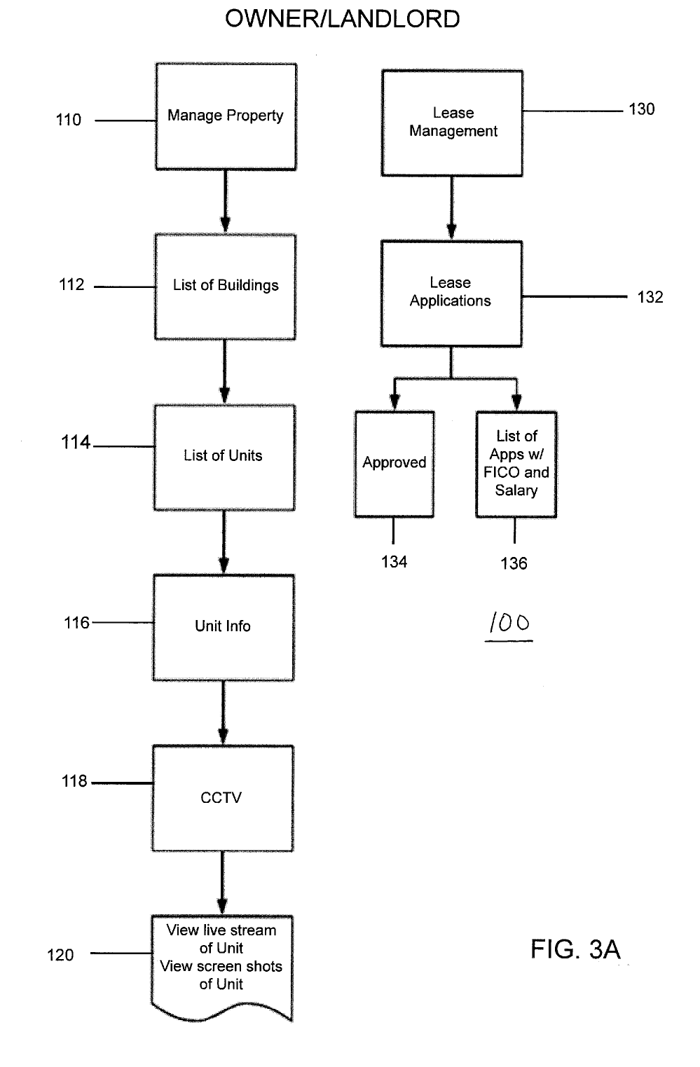

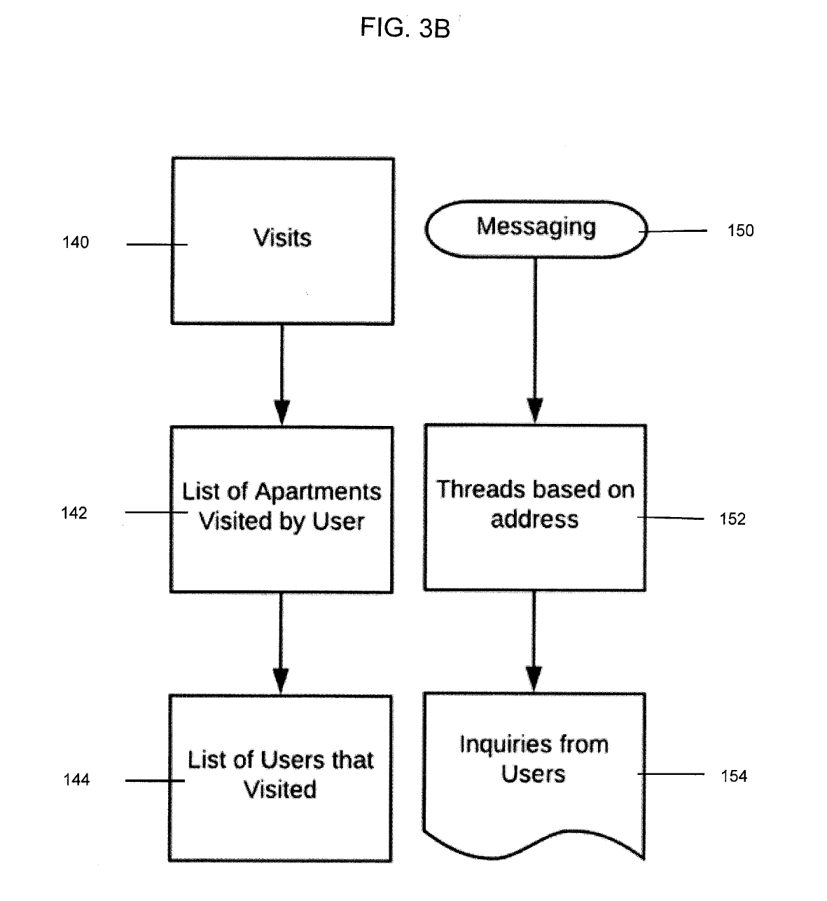

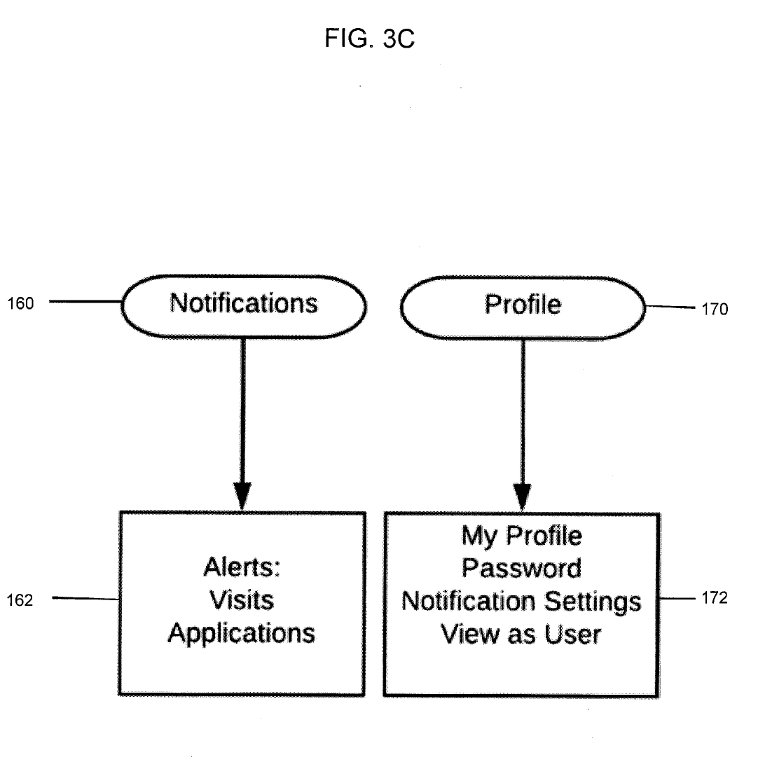

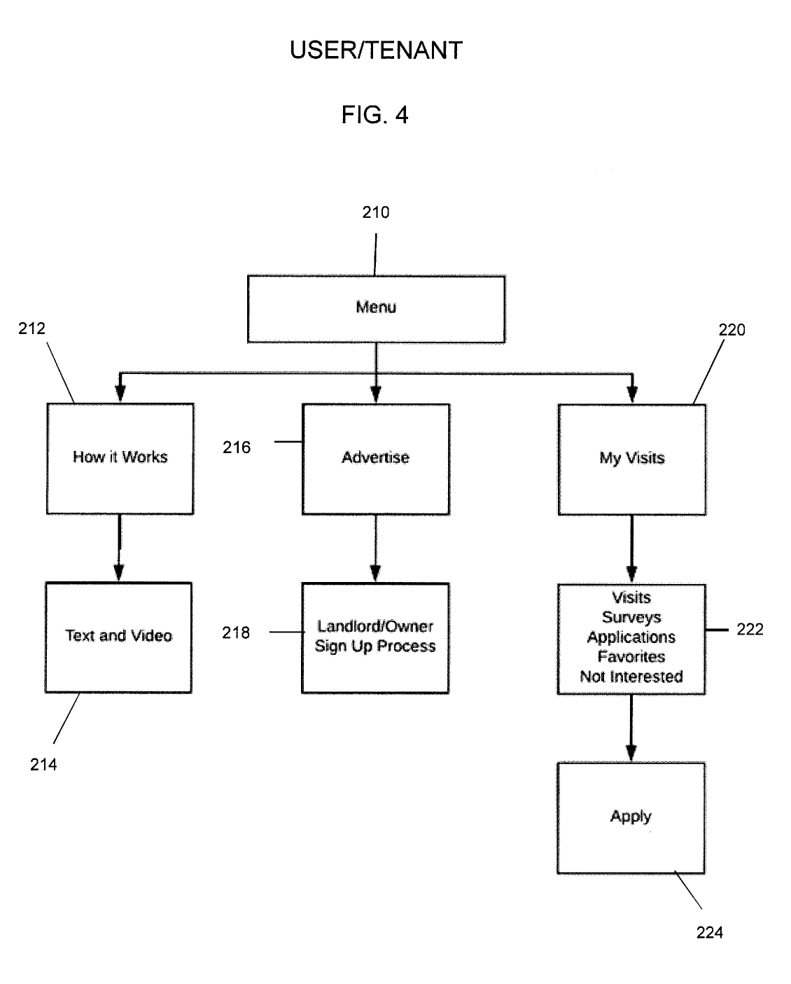

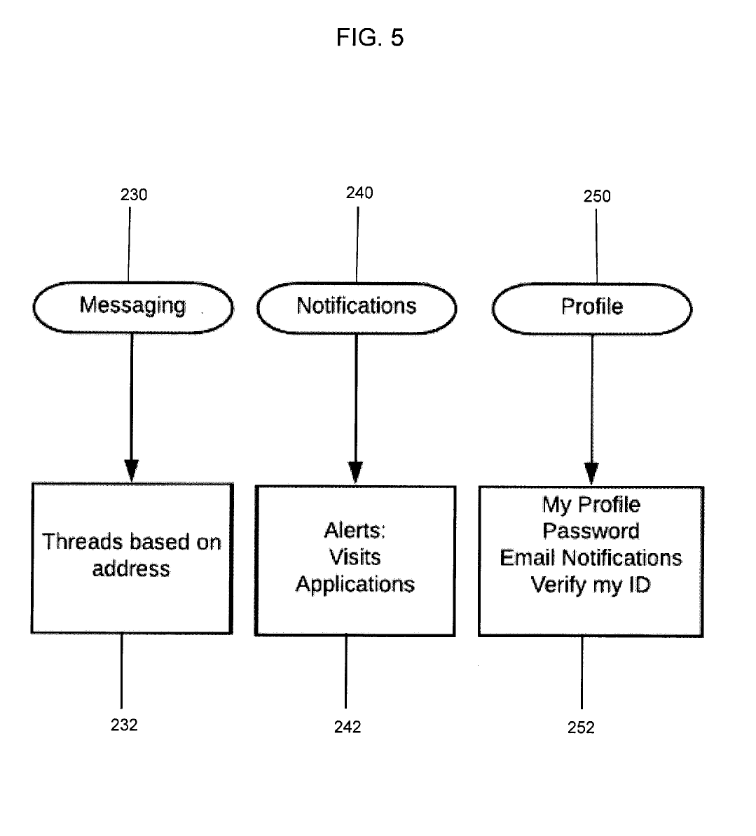

The above-described functionality and features of the present invention are further elucidated in the block diagram style FIGS. 3A through 6B. Referring to FIGS. 3A, 3B and 3C, the Owner/Landlord Software 100 for functionalities includes the overall Property Management Module 110 which provides the list of Building Module 112 that handles the list of buildings/locations where rentals are available, and the list of Units Module 114 and Unit Information Module 116 providing information about the individual units. The CCTV Module 118 is instrumental in allowing the View Live Stream Module 120 to provide to prospective renters a live stream of the unit including view screen shots of the unit.

The Lease Management Facility 130 includes the Lease Applications Module 132 which provides the prospective renters lease applications, the Approved Module 134 and the List of Apps with FICO and Salary Module 136 which are associated with the lease application module.

The Visits Facility 140 includes the List of Apartments Visited by User Module 142 and the List of Users that Visited Module 144 whose functionalities are self-evident from the module names themselves.

The Messaging Facility 150 includes the Threads Based on Address Module 152 and the Inquiries from Users Module 154 which similarly provides the functions indicated by their names. The Notification Facility 160 includes the Alerts: Visits Applications module 162, which is instrumental in setting up the unit inspections which assures that the different prospective renters appointments to view particular units do not clash or collide with one another. The Profile Facility 170 includes the MyProfile Password Notification Settings Module 172 which provides the individual users as indicated.

The overall User/Tenant Functionalities Facility 200 includes the Menu Module 210 which enables visitors to the website of the overall system of the present invention to access the How-It-Works Module 212 and the Text and Video Module 214. The Advertise Module 216 provides publicity and information dissemination of available units and the Landlord/Owner's Signup Process Module 218 performs the function indicated by its name. The My Visits Module 220 allows visitors to access information about their visits and schedules and is part of the overall User/Tenant System 200. The Visits|Surveys|Applications|Favorites|Not Interested Module 222 provides surveying and polling of prospective tenants to obtain for the system various helpful information. The Apply Module 224 utilizes the information from the Module 222 to improve the system. The User/Tenant Subsystem 200 also includes the Messaging Facility 230 which includes the Threads Based on Address Module 232. The Notifications Facility 240 includes the Alerts: Visits|Applications Module 242 that is responsible for performing the indicated function. Lastly, the Profile 250 provides the profiling password and email notification and Notifications Module 252 at the user-tenant level.

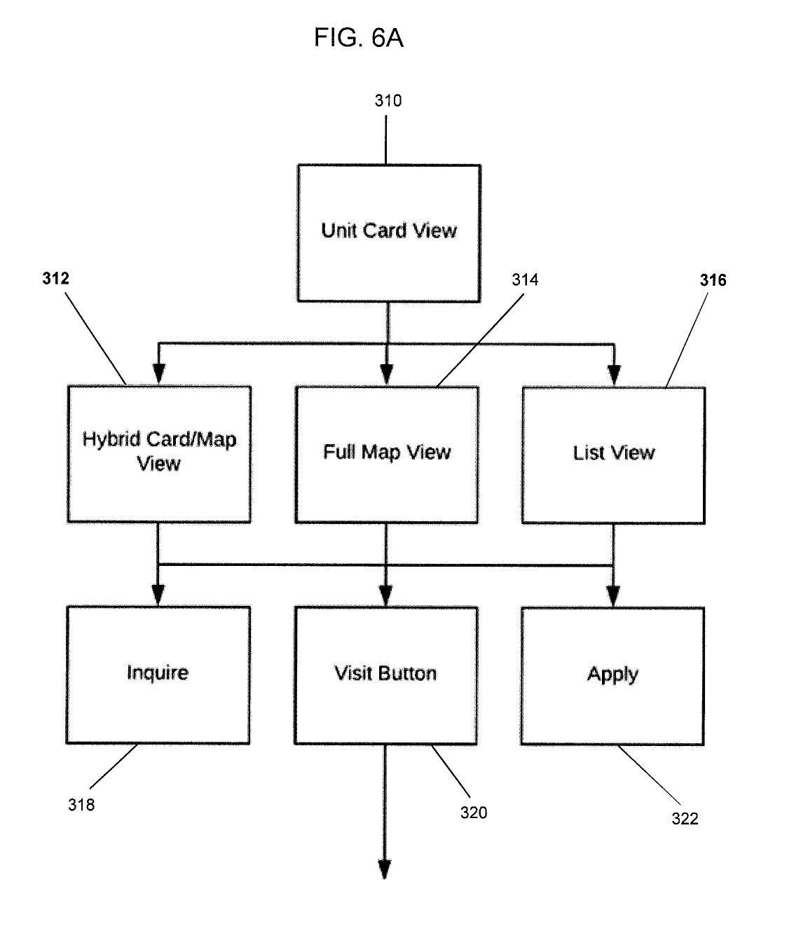

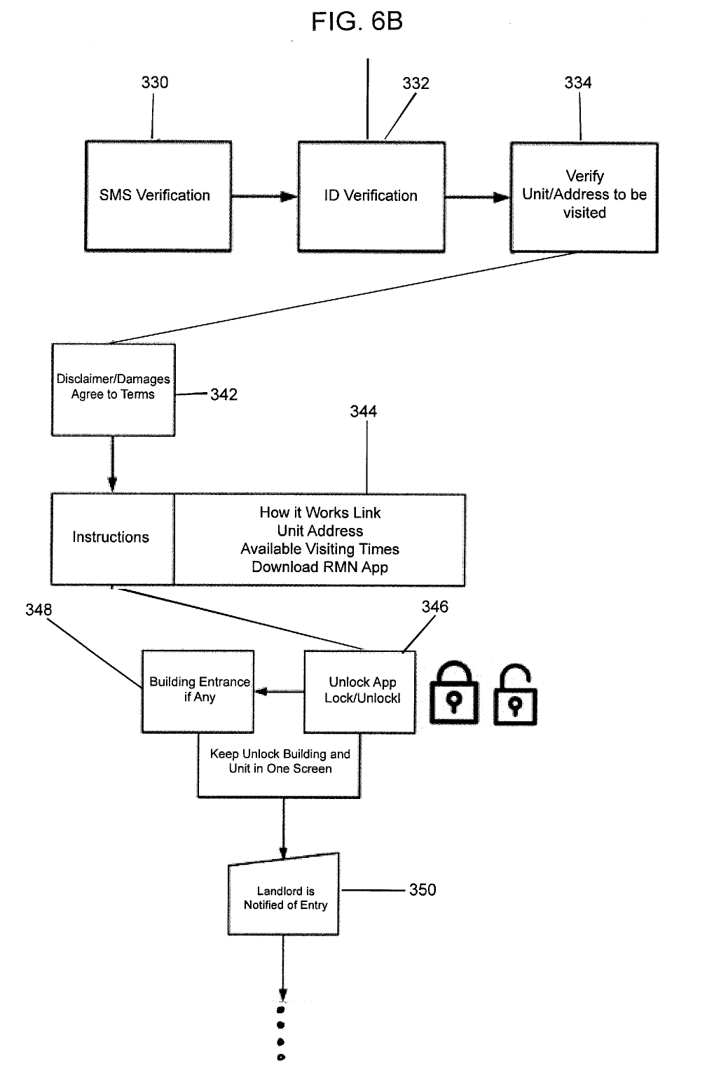

Turning to FIGS. 6A and 6B, the Software Subassembly 300 includes the Unit Card View Facility 310 which has overall flow management responsibility for handling the Hybrid Card/Map View Module 312, the Full Map View Module 314 and the List View Module 316 which control the functionalities that allow the renter to access the Inquire Module 318 which will lead one to set up a visit as well as the Visit Button Module 320 which allows pressing a button or an icon to schedule a visit at a unit after the formalities required by the Apply Module 322 have been attended to.

Once the Visit Module has been accessed, the user is directed to the SMS Verification Module 330, the ID Verification Module 332 and the Verify Unit/Address To Be Visited Module 334. Viewers are then led to the Disclaimer/Damages Agreement Module 342 which provides protections to the owner/lessors against any claims of the visitors followed by and once executed the user is led to the Instructions Module 344 that teaches the user how the overall system works and then provides information about unit address, available visiting times and allows downloading a Rental Application upon being fully set up the user is provided with the codes or access information to unlock and relock particular units in the Module 346 and then can operate the Building Entrance Lobby Facility 348 which then triggers a notification to the landlord in the Landlord Notification Module 350 when the prospective tenant has entered the premises.

Once the renter has entered the apartment, a Timer Module 352 is triggered to measure the time that the user is in the specific apartment and simultaneously causes the Camera-On Module 354 to turn on the internal cameras. The Visit Status Module 356 allows the system to ask the user if they are done or need more time. If more time is available and there is no conflict with other visits, such time is granted. Ultimately, the Landlord Notification Module 358 advises when the visit has been concluded and the prospective tenants have left. At the Module 380 the landlord receives an alert if the door has not properly locked. At the Modules 360, 362 and 364, a heuristic determination is made whether the visitor has left the premises and upon confirmation, the camera module turns the internal cameras off. The Survey Related Modules 366, 368 prompt a visitor to enter a survey to determine whether the apartment was in a presentable form and other information to rate the visiting experience. The survey includes the Modules 370, 374 and 376 which inquire and request the visitor to grade the visit as being positive or negative. At the same time, the Module 372 also interacts with the visitor to determine whether the visitor might be interested to apply for another unit or if the visit wants to defer on making an ultimate determination whether to lease the given apartment unit.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system for facilitating real estate (RE) unit rentals by intermediating landlords and potential tenants (PT) and enabling RE unit inspections and viewing without requiring on-site landlord representatives, the system comprising:
a master-server facility including software modules and databases for executing system algorithms that enable and control communications between landlord communication devices, PT devices and apartment devices;
a respective, remotely-operable and wirelessly controlled door lock installed on an entry door of the RE unit;
said apartment devices including communication and monitoring devices temporarily installed in the RE units to enable said RE unit inspections and viewing;
said software modules including at least:
a) a unit listing software module that receives unit listing information from the landlords, said information including and identifying the locations, identities and additional information for the RE units available for rental, said unit listing software module listing the RE units information in a manner accessible for viewing by the PT;
b) a tenant liaison module that is configured to allow tenants to communicate to the landlords their desire to inspect one or more specified ones of the listed RE units at desired time slots;
c) an inspection scheduling module that is configured to schedule inspection visits of a given PT, in a manner that does not conflict or interfere with previously scheduled inspections and prospective inspection schedules by other PT;
d) a door opening module that sends to the PT devices at least one activation code for the door lock; and
e) a tenant present module that verifies that the potential tenant is located in proximity to the entry door which enables the lock and activates the lock to unlock when activated by the PT devices.

2. The system of claim 1, wherein said door opening module is configured so that said door lock is activated to remain unlocked for a predetermined, programmable time period and self-locks thereafter.

3. The system of claim 1, wherein said apartment hardware comprises video equipment that produces live video content that is communicated to the master-server facility in a manner accessible to being remotely viewed.

4. The system of claim 1, wherein said apartment hardware comprises audio recording equipment for enabling audio communication of sounds within the RE unit and communicating said audio content to said master-server facility.

5. The system of claim 1, wherein said monitoring devices comprise several movement detectors temporarily located in the RE unit.

6. The system of claim 1, wherein said monitoring devices comprise perimeter protection devices that can be placed around valuable appliances in the RE unit and report any attempt to touch or remove said appliances.

7. The system of claim 1, wherein said software modules include an advertising module that is configured to place advertising content in advertising media channels, to advertise said available RE units and to provide directions to access the system of the present invention to view said RE units.

8. The system of claim 1, wherein said apartment devices comprise a lobby door controller and wherein said software modules comprise lobby door control software that operates to enable the PT to gain access to a multi-dwelling apartment unit through a lobby door.

9. The system of claim 1, wherein said tenant present module comprises a facility that is GPS activated and which is configured to transmit to the master-server facility GPS coordinates corresponding to a physical location of the PT, to assure that the PT device is located adjacent to the door lock.

10. The system of claim 1, wherein said software modules include a leasing services module configured to provide to the PT leasing forms and information that streamlines letting of the RE units.

11. The system of claim 1, wherein said software module comprises a PT communication module that is configured to allow the PT who had inspected the RE units to provide feedback information and comments to the landlords.

12. The system of claim 1, wherein said software module comprises a landlord report module that provides regular and organized reports on the apartment inspections and leasing of the RE units.

13. The system of claim 1, wherein said software module comprises a PT verification module, which is configured to conduct background investigations and verifications of the PTs before authorizing PTs for scheduled inspections of the RE units.

14. The system of claim 1, wherein said software module comprises an information organizing module, that is configured to allow PTs to segregate information about the RE units relative to geographical locations, particular landlords, rent levels, and/or RE unit apartment sizes.

15. The system of claim 5, wherein said tenant-present module comprises a facility that randomly activates said movement devices to detect movements inside said RE units during times when no one has been scheduled to be in the RE unit.
